(19) United States
(12) Patent Application Publication
(10) Pub. No.: US 2012/0033336 A1
(43) Pub. Date: Feb. 9, 2012

(54) DEBUG INTERFACE CIRCUIT AND ELECTRONIC DEVICE USING THE SAME

(75) Inventor: XING-HUA TANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/914,933

(22) Filed: Oct. 28, 2010

(30) Foreign Application Priority Data
Aug. 3, 2010 (CN) 201010243861.4

(51) Int. Cl. H02H 9/00

(52) U.S. Cl. 361/56

(57) ABSTRACT

A debug interface circuit connecting between a connector and an integrated circuit (IC) of an electronic device. The connector is used for providing a path for a debug device debugging the IC. The debug interface circuit includes a first electrostatic protection unit and a second electrostatic protection unit. One end of the first electrostatic protection unit is electrically connected between a first pin of the IC and an output port of the connector, and the other end of the first electrostatic protection unit is electrically grounded. One end of the second electrostatic protection unit is electrically connected between a second pin of the IC and an input port of the connector, and the other end of the second electrostatic protection unit is electrically grounded. The first pin is used for receiving signals from the output port. The second pin used for transmitting signals to the input port.

### BACKGROUND

1. Technical Field

The present disclosure relates to electronic devices, and particularly to an electronic device using a debug interface circuit for preventing the electronic device from being damaged by electrostatic discharge (ESD).

2. Description of Related Art

Integrated circuits (IC) are widely used in different electronic devices for processing data or power management. The IC is tested after being installed on the electronic device by a debug device. The debug device electrically connects to the IC by a debug interface circuit of the electronic device. Usually, the debug interface circuit is a recommend standard 232 (RS-232) connector. The RS-232 connector includes some exposed conductive pins for connecting with the debug device. However, the exposed conductive pins can be accidentally touched by users, and static electricity accumulated on the user may discharge to the pins and damage the IC. Thus, the IC is easy to be damaged from electrostatic discharge (ESD) through the RS-232 connector.

Therefore, there is room for improvement in the art.

### BRIEF DESCRIPTION OF THE DRAWINGS

The components of the drawings are not necessarily drawn to scale, the emphasis instead being placed upon clearly illustrating the principles of the embodiment of an electronic device with a debug interface circuit. Moreover, in the drawings, like reference numerals designate corresponding parts throughout the views.

FIG. 1 is a schematic view of an electronic device including a debug interface circuit according to an exemplary embodiment.

FIG. 2 is a schematic view of an electronic device including a debug interface circuit according to another exemplary embodiment.

### DETAILED DESCRIPTION

Embodiments of the present disclosure will now be described in detail with reference to the drawings.

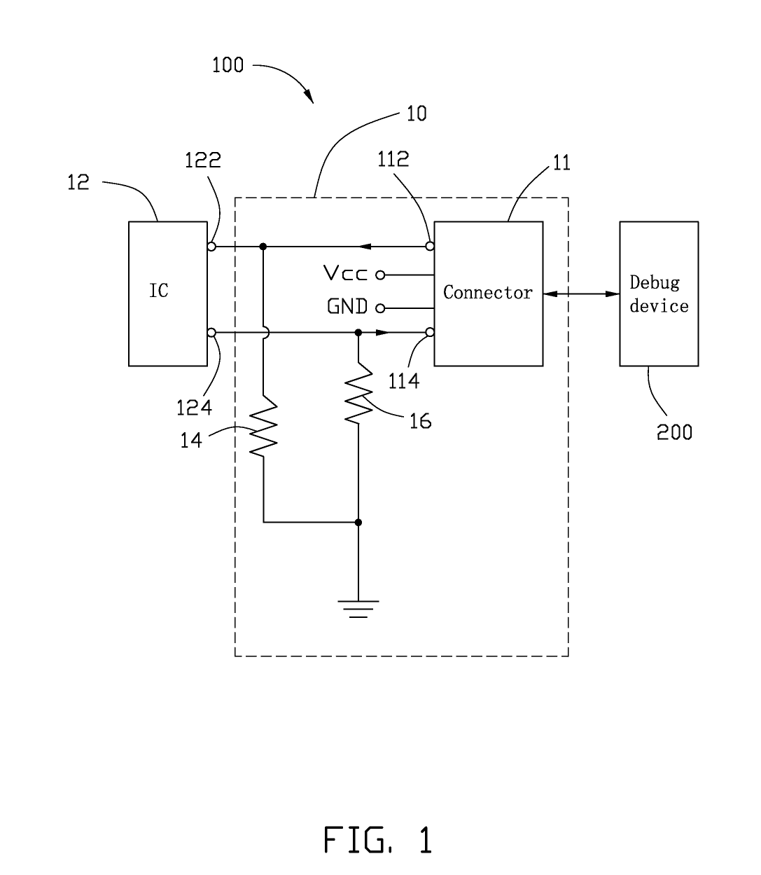

Referring to FIG. 1, an electronic device 100 according to an exemplary embodiment is illustrated. In this embodiment, the electronic device 100 is a DVD player. The electronic device 100 includes an integrated circuit (IC) 12 and a debug interface circuit 10 electrically connected to the IC 12. The debug interface circuit 10 is used for electrically connecting the IC 12 to a debug device 200. The debug device 200 is a computer used for debugging the IC 12.

The IC 12 includes a first pin 122 for inputting external signals, and a second pin 124 for outputting internal signals.

The debug interface circuit 10 includes a connector 11, a first electrostatic protection unit 14, and a second electrostatic protection unit 16.

In this embodiment, the connector 11 is a recommended standard 232 (RS-232) connector. The RS-232 is exposed out side of the electronic device 100 and is capable of electrically connecting to the debug device 200. The RS-232 connector includes an output port 112, an input port 114, a power port Vcc for electrically connecting to a power Vcc of the electronic device 100, and a ground port GND for being electrically grounded. The output port 112 is electrically connected to the first pin 122, for outputting signals to the first pin 122. The input port 114 is electrically connected to the second pin 124, for inputting signals from the second pin 124.

One end of the first electrostatic protection unit 14 is electrically connected to the first pin 122, and the other end of the first electrostatic protection unit 14 is electrically grounded. The first electrostatic protection unit 14 is used for clamping a voltage of the first pin 122 at a predetermined value. The predetermined value is set lower than a threshold above which the IC 12 may be damaged. One end of the second electrostatic protection unit 16 is electrically connected to the second pin 124, and the other end of the second electrostatic protection unit 16 is electrically grounded. The second electrostatic protection unit 16 is used for clamping a voltage of the second pin 124 at the predetermined value. Thus, the IC 12 is protected from the damage caused by ESD to the connector 11.

Generally, during an ESD event, high voltage, such as 10 KV, is generated momentarily. When the debug device 200 turns on and electrically connects to the connector 11, the first electrostatic protection unit 14 and the second electrostatic protection unit 16 respectively clamp the voltages of the first pin 122 and the second pin 124 at the predetermined value. In this embodiment, the first electrostatic protection unit 14 is a first voltage dependent resistor, and the second electrostatic protection unit 16 is a second voltage dependent resistor. When current through the first pin 122 and the second pin 124 are too great, the resistances of the first voltage dependent resistor and the second voltage dependent resistor become low to guide part of the current to ground. When current through the first pin 122 and the second pin 124 are safe, the resistances of the first voltage dependent resistor and the second voltage dependent resistor become high blocking the path to ground.

As discussed above, when the electronic device 100 is electrically connected to the debug device 200 for debugging the IC 12, the IC 12 is protected from ESD damage.

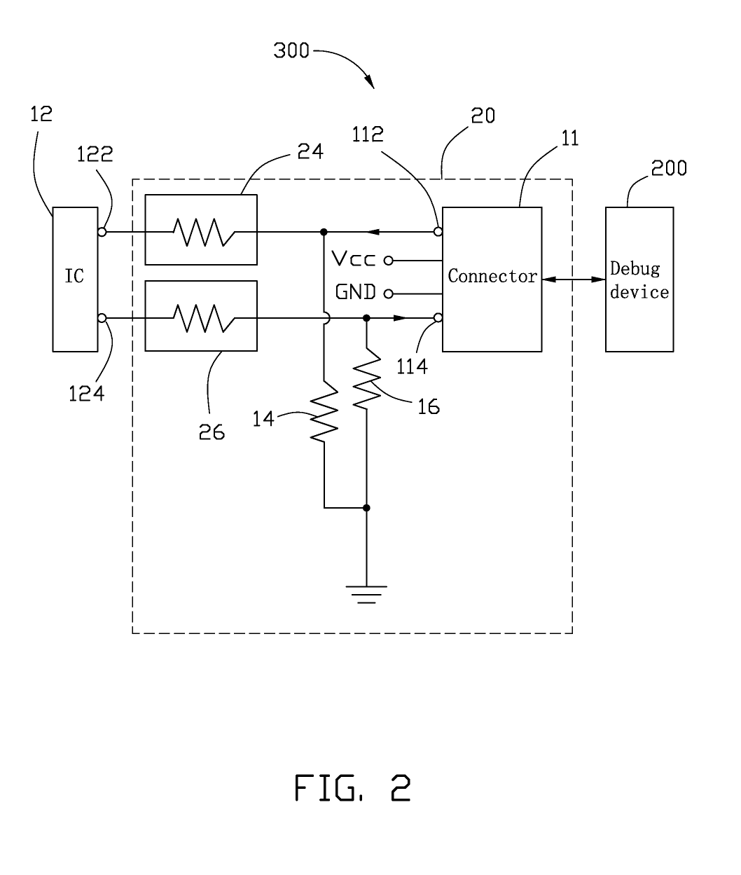

Referring to FIG. 2, an electronic device 300 according to another exemplary embodiment is illustrated. The difference between the electronic device 100 and the electronic device 300 is that the electronic device 300 further includes a first current limiting unit 24 and a second current limiting unit 26.

The first current limiting unit 24 is electrically connected between the first pin 122 of the IC 12 and the output port 112 of the connector 11. The second current limiting unit 26 is electrically connected between the second pin 124 of the IC 12 and the input port 114 of the connector 11. The first current limiting unit 24 limits an ESD current to a safe value, the ESD occurring on the output port 112 of the connector 11. The second current limiting unit 26 is used for limiting an ESD current to a safe value, which the ESD occurred on the input port 114 of the connector 11. In this embodiment, the first current limiting unit 24 is a first resistor, the second current limiting unit 26 is a second resistor.

The electronic device 300 has the same advantages as the electronic device 100, but further has double electrostatic protections on the IC 12.

While various exemplary and preferred embodiments have been described, it is to be understood that the disclosure is not limited thereto. To the contrary, various modifications and similar arrangements (as would be apparent to those skilled in the art) are intended to also be covered. Therefore, the scope of the appended claims should be accorded the broadest interpretation to encompass all such modifications and similar arrangements.

What is claimed is:

1. A debug interface circuit connected between a connector and an integrated circuit (IC) of an electronic device, the connector for providing a path for a debug device debugging the IC, the debug interface circuit comprising:
a first electrostatic protection unit, one end of the first electrostatic protection unit electrically connected between a first pin of the IC and an output port of the connector, the other end of the first electrostatic protection unit electrically grounded, the first pin used for receiving signals from the output port; and
a second electrostatic protection unit, one end of the second electrostatic protection unit electrically connected between a second pin of the IC and an input port of the connector, the other end of the second electrostatic protection unit electrically grounded, the second pin used for transmitting signals to the input port.

2. The debug interface circuit of claim 1, wherein the first electrostatic protection unit is used for clamping a voltage of the first pin to a predetermined value which is set to be lower than a threshold above which the IC may be damaged, the second electrostatic protection unit is used for clamping a voltage of the second pin to the predetermined value.

3. The debug interface circuit of claim 1, wherein the first electrostatic protection unit comprises a voltage dependent resistor.

4. The debug interface circuit of claim 1, wherein the second electrostatic protection unit comprises a voltage dependent resistor.

5. The debug interface circuit of claim 1, further comprising a first current limiting unit used for limiting an ESD current to a safe value, which the ESD occurred on the output port of the connector.

6. The debug interface circuit of claim 5, further comprising a second current limiting unit used for limiting an ESD current to a safe value, which the ESD occurred on the input port of the connector.

7. The debug interface circuit of claim 6, wherein the first current limiting unit comprises a first resistor.

8. The debug interface circuit of claim 7, wherein the second current limiting unit comprises a second resistor.

9. An electronic device, comprising:
an integrated circuit (IC) comprising:
a first pin for inputting external signals; and
a second pin for outputting internal signals;
a connector for electrically connecting the IC to a debug device and for providing a path for a debug device debugging the IC, the connector comprising:
an output port for electrically connecting to the first pin; and
an input port for electrically connecting to the second pin;
a first electrostatic protection unit, one end of the first electrostatic protection unit electrically connected between the first pin and the output port, the other end of the first electrostatic protection unit electrically grounded; and
a second electrostatic protection unit, one end of the second electrostatic protection unit electrically connected between the second pin and the input port, the other end of the second electrostatic protection unit electrically grounded.

10. The electronic device of claim 9, wherein the first electrostatic protection unit is used for clamping a voltage of the first pin to a predetermined value which is set to be lower than a threshold above which the IC may be damaged, the second electrostatic protection unit is used for clamping a voltage of the second pin to the predetermined value.

11. The electronic device of claim 9, wherein the first electrostatic protection unit comprises a voltage dependent resistor.

12. The electronic device of claim 9, wherein the second electrostatic protection unit comprises a voltage dependent resistor.

13. The electronic device of claim 9, further comprising a first current limiting unit used for limiting an ESD current to a safe value, which the ESD occurred on the output port of the connector.

14. The electronic device of claim 13, further comprising a second current limiting unit used for limiting an ESD current to a safe value, which the ESD occurred on the input port of the connector.

15. The electronic device of claim 14, wherein the first current limiting unit comprises a first resistor.

16. The electronic device of claim 15, wherein the second current limiting unit comprises a second resistor.

17. An electronic device, comprising:
an integrated circuit (IC) comprising:
a first pin for inputting external signals; and
a second pin for outputting internal signals;
a connector for electrically connecting the IC to a debug device and for providing a path for a debug device debugging the IC, the connector comprising:
an output port for electrically connecting to the first pin; and
an input port for electrically connecting to the second pin;
a first electrostatic protection unit used for clamping a voltage of the first pin to a predetermined value which is set to be lower than a threshold above which the IC may be damaged; and
a second electrostatic protection unit is used for clamping a voltage of the second pin to the predetermined value.

18. The electronic device of claim 17, wherein the first electrostatic protection unit comprises a first voltage dependent resistor, and the second electrostatic protection unit comprises a second voltage dependent resistor, one end of the first voltage dependent resistor is electrically connected between the first pin and the output port, the other end of the first voltage dependent resistor is electrically grounded, one end of the second voltage dependent resistor is electrically connected between the second pin and the input port, the other end of the second voltage dependent resistor is electrically grounded.

19. The electronic device of claim 17, further comprising a first current limiting unit used for limiting an ESD current to a safe value, which the ESD occurred on the output port of the connector, and a second current limiting unit used for limiting an ESD current to a safe value, which the ESD occurred on the input port of the connector.

20. The electronic device of claim 19, wherein the first current limiting unit comprises a first resistor, and the second current limiting unit comprises a second resistor.
